(19) United States
(12) Patent Application Publication
(10) Pub. No.: US 2012/0116922 A1
(43) Pub. Date: May 10, 2012

(54) Method and System for Managing On-Line Market with Direct Receipt Delivery Option of Purchased Merchandise

(75) Inventor: Young Bae Ku, Seoul (KR)

(73) Assignee: GMARKET INC., Seoul (KR)

(21) Appl. No.: 12/672,774

(22) PCT Filed: Aug. 6, 2008
(86) PCT No.: PCT/KR2008/004555

§ 371 Date: May 3, 2010

(30) Foreign Application Priority Data
Aug. 10, 2007 (KR) 10-2007-0080504

(51) Int. Cl. G06Q 30/06

(52) U.S. Cl. 705/27.1

(57) ABSTRACT

The present invention relates to an online market management method and system capable of supporting a delivery option for direct pickup of purchased products. The present invention is constructed such that, when a purchaser who purchases a product traded on an online market selects a delivery option requesting the direct pickup of a product, the method and system verify an authentication key, issued by the online market in various forms to the purchaser, at a product pickup place agreed upon with a merchant, and allow the purchaser to directly pick up the purchased product. In the online market management method, a delivery option for direct pickup of a product, for which payment has been completed by a purchaser, is selected through a server for mediating trading of products. Thereafter, the server performs authentication to identify the purchaser and updating delivery information about the product for which payment has been completed if authentication information, provided in real time by the server to a purchaser terminal, or authentication information, previously assigned to the purchaser, has been input through a merchant terminal depending on the selection of the delivery option for direct pickup.

### TECHNICAL FIELD

The present invention relates, in general, to an online market management method and system, and, more particularly, to an online market management method and system, which are constructed such that, when a purchaser who purchases a product traded on an online market selects a delivery option requesting the direct pickup of a product, the method and system verify an authentication key, issued by the online market in various forms to the purchaser, at a product pickup place agreed upon with a merchant, and allow the purchaser to directly pick up the purchased product, so that the purchaser can reduce delivery costs and the merchant can improve work efficiency by simplifying a delivery process, thus allowing the merchant to reward purchasers for profit generated at that time in the form of supplementary service, such as price discounts or the provision of promotional gifts, and further promoting the activation of online markets.

### BACKGROUND ART

Generally, when buying a product from an online market, a purchaser receives the purchased product in the method shown in FIG. 1. For example, in order to purchase a required product, the purchaser selects a product having a suitable price while viewing an online market, such as a shopping mall site implemented on the Internet, at step S110. In order for the purchaser to receive the selected product, the purchaser must input delivery place information into a predetermined payment page on the screen, or must confirm the delivery place information at step S120. The delivery place information in the payment page may be automatically displayed with reference to member information registered at the time of subscription as a member, and the purchaser may make payment after confirming or changing the delivery place information.

Generally, in most cases, a purchaser designates his or her place of residence as the delivery place. In addition, there is an attempt to select a number of depositories, in which places such as convenience stores and pharmacies are registered as affiliated stores, thus solving the problem of delivery delay occurring due to the absence of recipients or traffic congestion. Further, a method similar to the above method is disclosed in Korean Pat. Laid-Open Publication No. 10-2005-0109212, and is configured such that logistics outlets for respective areas, operated by a delivery company, are selected as delivery places, thus enabling products to be safely delivered at a convenient time at low cost.

In this way, if a required process, such as the entry of a contact number and the payment of an amount of money, is completed after a delivery place has been selected, a merchant selects a delivery company and delivers the purchased product using the selected delivery company at step S130. The delivery company manages invoice numbers for respective products to be delivered and also notifies the online market of the invoice numbers at step S140. The delivery company, the merchant and the purchaser can track the position of the purchased product using a corresponding invoice number until the purchaser safely receives the product at step S150.

However, the delivery method of delivering products to delivery places using a delivery company is problematic in that a purchaser must bear the burden of delivery costs, and a merchant must spend time and money in the process of preparing for delivery, such as the packaging of products for delivery, the selection of a delivery company, and the transfer of products to a delivery person.

Further, since the delivery company having a contract with a merchant gathers all of the products at its centralized logistics center and then delivers respective products to purchasers, regardless of whether the distance to purchasers is short or king, existing delivery logistics are problematic in that delivery costs are not saved if the distance between the merchant and a purchaser is very short, and in that the time taken to deliver respective products to purchasers cannot be reduced. Consequently, the present invention has been proposed to solve such problems. That is, an online shopping mall is configured to allow a purchaser to personally visit a merchant and directly pick up a product from the merchant at the option of the purchaser if the distance between the logistics warehouse of the merchant and the purchaser is very short, and to allow the purchaser to be rewarded in the form of a discounted price or a predetermined service, which is designated by the merchant, without causing the inconvenience of requesting a separate discount from the merchant or bargaining with the merchant for supplementary service when the purchaser directly receives the product in this way, thus enabling the entire procedure to be smoothly processed.

### DISCLOSURE OF INVENTION

### Technical Problem

Accordingly, the present invention has been made keeping in mind the above problems occurring in the prior art, and an object of the present invention is to provide an online market management method and system, in which, in order for a purchaser who purchases a product traded on an online market to save delivery costs and for a merchant to improve work efficiency by simplifying the delivery process, the purchaser can select a delivery option requesting the direct pickup of purchased products, and Can directly pick up the product at a product pickup place agreed upon with the merchant after an authentication key, issued by the online market to the purchaser in various forms, has been verified at the product pickup place.

Another object of the present invention is to provide an online market management method and system, in which a merchant supporting the selection of a delivery option for direct pickup rewards a purchaser for profit generated through the option in the form of a supplementary service such as price discounts or the provision of promotional gifts, thus stimulating purchasers to purchase products and consequently further activating the use of online markets.

### Technical Solution

In accordance with an aspect of the present invention to accomplish the above objects, there is provided an online market management method, comprising selecting a delivery option for direct pickup of a product, for which payment may be completed by a purchaser, through a server for mediating trading of products; and the server performing authentication to identify the purchaser and updating delivery information about the product if authentication information, provided in real time by the server to a purchaser terminal, or authentication information, previously assigned to the purchaser, has been input through a merchant terminal depending on the selection of the delivery option for direct pickup.

In accordance with another aspect of the present invention to accomplish the above objects, there is provided an online market management method of managing an online market through a server for mediating trading of products between a merchant and a purchaser, comprising providing pickup information, including information about a pickup place, to a purchaser terminal if a delivery option for direct pickup of a product of the purchaser, for which payment may be completed, is selected; and updating delivery information about the product when authentication information to identify the purchaser has been input through a merchant terminal at the pickup place.

In accordance with a further aspect of the present invention to accomplish the above objects, there is provided an online market management system, comprising an online market server for mediating trading of products over an Internet, the online market server comprising a control unit for controlling registration of products by a merchant, purchase of products by a purchaser, and a delivery process of each product for which payment has been completed, wherein the control unit is configured to control performance of authentication to identify the purchaser and update of delivery information about a product, for which payment may be completed, based on results of authentication if a delivery option for direct pickup of the product, is selected through a purchaser terminal, and then authentication information, provided in real time by the online market server to the purchaser terminal, or authentication information, previously assigned to the purchaser, is input through a merchant terminal depending on the selection.

In accordance with yet another aspect of the present invention to accomplish the above objects, there is provided an online market management system for mediating trading of products between a merchant and a purchaser, comprising a trading mediation unit for providing payment page information about a product of a merchant, selected by a purchaser, to a purchaser terminal; a delivery option setting unit for providing pickup information, including information about a pickup place, to the purchaser terminal when a delivery option for direct pickup of a product for which payment may be completed by the purchaser is selected on a basis of the payment page information; and an authentication processing unit for updating delivery information about the product when authentication information to identify the purchaser is input through a merchant terminal at the pickup place.

### Advantageous Effects

According to the online market management method and system, there are advantageous in that, when a purchaser who purchased a product traded on an online market selects a delivery option requesting the direct pickup of the product, an authentication key, issued by the online market to the purchaser in various forms, is verified at a product pickup place agreed upon with a merchant, and thereafter the purchaser can directly pick up the product, thus allowing the purchaser to save delivery costs and allowing the merchant to improve work efficiency through the simplification of the delivery process.

Further, according to the online market management method and system, there are advantages in that a merchant supporting the selection of a delivery option for direct pickup can reward purchasers for profit attributable to the option in the form of a supplementary service, such as price discounts or the provision of promotional gifts, thus stimulating purchasers to purchase the product and further stimulating the use of online markets.

Further, according to the method and system for managing an online market, there are advantages in that a combined scheme is applied in such a way that a delivery method allowing a purchaser to directly pick up a product offline, without requiring the management of invoice numbers handled by a delivery company, is used, but the process for delivery confirmation or purchase decision (receipt confirmation) is performed online, thus enabling the scheme of the present invention to be conveniently and flexibly employed in product selection-type shopping malls managed by merchants or agents, as well as auction-type shopping malls.

### BRIEF DESCRIPTION OF THE DRAWINGS

FIG. 1 is a flowchart showing a conventional online market management method;

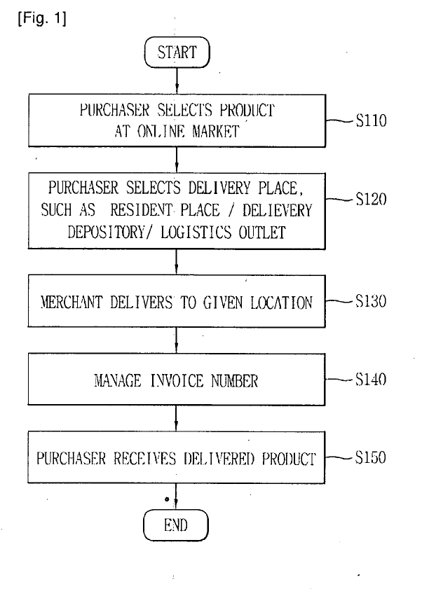

FIG. 2 is a diagram showing an online market management system according to an embodiment of the present invention;

FIG. 3 is, a diagram showing the relationships between a purchaser, a merchant and an online market;

FIG. 4 is a block diagram showing an online market server according to an embodiment of the present invention;

FIG. 5 is a diagram showing an example of a payment page;

FIG. 6 is a diagram showing an example of a merchant page;

FIG. 7 is a diagram showing an example of a purchaser page; and

FIG. 8 is a flowchart showing an online market management method according to an embodiment of the present invention.

### MODE FOR THE INVENTION

Hereinafter, embodiments of the present invention will be described in detail with reference to the attached drawings. However, the present invention is not limited to the above embodiments. The same reference numerals are used throughout the different drawings to designate the same or similar components.

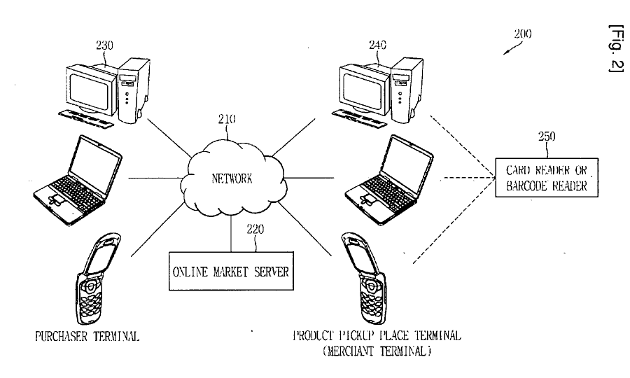

FIG. 2 is a diagram showing an online market management system 200 according to an embodiment of the present invention. Referring to FIG. 2, the online market management system 200 according to an embodiment of the present invention includes a network 210, an online market server 220, a purchaser terminal 230, a merchant terminal 240, and a card reader or barcode reader 250.

Here, the network 210 may be the wired or wireless Internet, a wired public network, a wireless mobile communication network, or a core network combined with the mobile Internet. The online market server 220, which is a server for managing an online shopping mall through the network 210 and mediating the trading of products between a merchant and a purchaser, receives and registers information about various types of products handled by the merchant from the merchant terminal 240 through the network 210, and provides the information about the registered products to the purchaser terminal 230 through the network 210, thus allowing the purchaser to purchase a required product. The online market server 220 can process payment for a product determined to be purchased and selected by the purchaser from a list of products for sale, and can process a delivery procedure, such as by notifying the merchant of the product for which payment has been completed, or a procedure, such as by tracking the position of the product being delivered or inquiring about the results of delivery, in order to deliver the product for which payment has been completed to the purchaser.

Typically, the purchaser terminal 230 and the merchant terminal 240 are computers, such as desktop PCs or notebook PCs, but are not limited thereto, and may be all types of wired/wireless communication devices capable of accessing the online market server 220 through the network 210 and utilizing bidirectional service to mediate product trading. For example, the purchaser terminal 230 and the merchant terminal 240 may include mobile terminals for performing communication through the wireless Internet or the mobile Internet, such as cellular phones, Personal Communications Services (PCS) phones, and synchronous/asynchronous International Mobile Telecommunications (IMT)-2000 terminals, and may include all wired/wireless household/communication devices, each having a user interface to access the online market server 220, such as Palm Personal Computers (Palm PCs), Personal Digital Assistants (PDAs), smart phones, Wireless Application Protocol (WAP) phones, and mobile gaming devices, in addition to the mobile terminals.

The present invention is configured such that, in particular, the online market server 220 supports a delivery method allowing a purchaser to directly pick up a purchased product offline, without managing invoice numbers handled by a delivery company, and performs a procedure such as delivery confirmation for direct pickup or purchase decision (receipt confirmation) online.

For this purpose, the online market management system 200 according to an embodiment of the present invention is configured such that, if a delivery option for direct pickup of a product for which payment may be completed by the purchaser is selected through the online market server 220, and then authentication information (for example, an authentication key corresponding to at least one of Arabic numerals, identifiable characters, and barcode information) provided by the online market server 220 in real time to the purchaser terminal 230 or authentication information previously assigned to the purchaser (for example, the member information of a membership card issued by a manager) is input through the merchant terminal 240 depending on the selection, the online market server 220 performs authentication for identifying the purchaser, and then updates delivery information about the product for which payment may be completed. The membership card or printed sheet on which the barcode information is printed can be read by the card reader or barcode reader 250, and member information or an authentication code, which has been read and output, can be input to the merchant terminal 240.

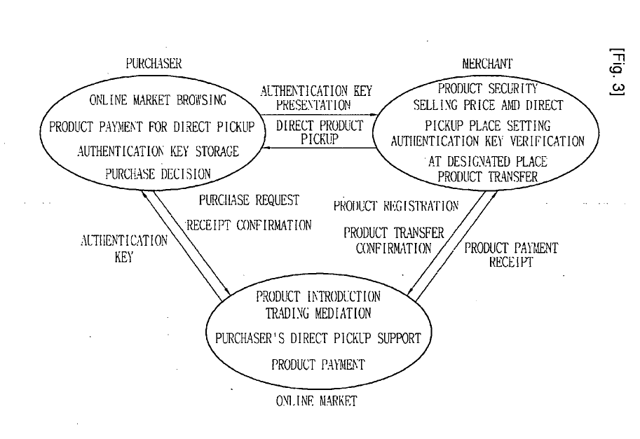

FIG. 3 is a diagram showing the relationships between a purchaser, a merchant, and an online market. According to the present invention, when the merchant sets selling prices, a direct pickup place, benefits for direct pickup, etc., for products secured for sales, and registers the products on the online market, the online market introduces the products registered by the merchant to shopping malls, and mediates the trading of the products with purchasers. A purchaser selects a desired product while browsing the online market to purchase the desired product, and requests the purchase of the product by selecting a delivery option for direct pickup at the time of payment. Accordingly, when the online market assigns an authentication key for the product for which payment may be completed to the purchaser in the case of the delivery option for direct pickup in various forms, such as Arabic numerals, identifiable characters (including Korean, English, and symbols, such as *, $, % and &), barcode information, and a membership card, the purchaser presents the authentication key to the merchant to verify the identity thereof at the direct pickup place for the product and the merchant transfers the product to the purchaser when authentication of the purchaser has succeeded. At this time, when the merchant notifies the online market of confirmation that the product has been successfully transferred to the purchaser, the delivery information of the product can change from ‘pending delivery’ to ‘enroute’ or ‘delivery complete’ according to the circumstances. After directly picking up the product, the purchaser can examine the product for defects or quality immediately at the pickup place or later, and can make a final decision whether to purchase or return the product and notify the online market of the results of the decision. At this time, when notification of the purchaser's intention to receive the product is provided, the online market completes the mediation of the trading of the product, subtracts a commission, predetermined according to a commission policy, from the total amount of money paid, which is deposited at the time of payment, and sends the remaining amount of money to the merchant.

As described above, the present invention is configured such that a purchaser who purchased a product traded on an online market can select a delivery option allowing the purchaser to directly pick up the product, and can directly pick up the product after an authentication key, issued to the purchaser by the online market, has been verified at the product pickup place agreed upon with a merchant. Accordingly, the purchaser can save delivery costs, and the merchant can improve work efficiency by simplifying the delivery process. As a result, the merchant can make a profit and can reward purchasers who select the delivery option for direct pickup in the form of price discounts for the products or promotional gifts. Such a supplementary service provided by the merchant can stimulate purchasers to purchase the product, thus further activating the use of the online market.

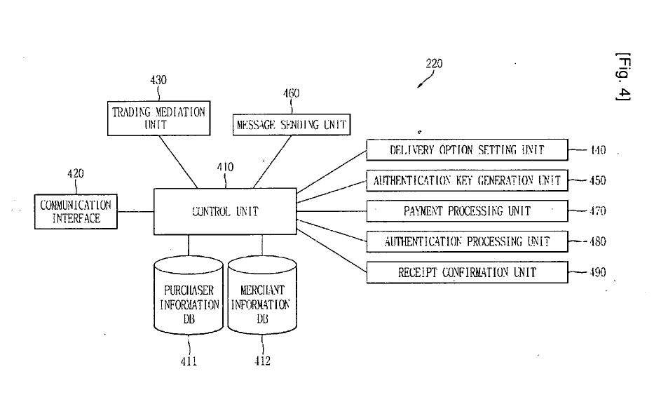

FIG. 4 is a block diagram showing the online market server 220 according to an embodiment of the present invention. Referring to FIG. 4, the online market server 220 according to an embodiment of the present invention includes a control unit 410, a purchaser information DB 411, a merchant information DB 412, a communication interface 420, a trading mediation unit 430, a delivery option setting unit 440, an authentication key generation unit 450, a message sending unit 460, a payment processing unit 470, an authentication processing unit 480, and a receipt confirmation unit 490.

The control unit 410 is a processor for controlling the registration of products by merchants, the purchase of products by purchasers, and the delivery process of products for which payment has been completed, and additionally controlling the overall operation of respective components included in the online market server 220. In particular, in order to enable a product for which payment has been completed to be securely and successfully transferred to a purchaser and manage payment information or delivery information about the product, the control unit 410 controls the performance of authentication for identifying the purchaser and the update of delivery information about the product for which payment may be completed based on the results of authentication if the delivery option for direct pickup of the product for which payment May be completed by the purchaser is selected through the purchaser terminal 230, and then authentication information (for example, an authentication key corresponding to at least one of Arabic numerals, identifiable characters, and barcode information), provided in real time by the online market server 220 to the purchaser terminal 230, or authentication information (for example, the member information of a membership card issued by a manager), previously held by the purchaser, is input through the merchant terminal 240 depending on the selection.

The merchant terminal 240 can access the online market server 220 over the network 210 and can use the product trading mediation service provided by the online market server 220 according to the processing of wired/wireless communication performed by the communication interface 420. Each merchant can subscribe to the service of the on line market server 220 as a member who is a client using the service through the merchant terminal 240. Merchant information registered by the merchant who subscribed as a member, for example, a merchant ID, a password, a contact address, selling prices of products, the brand of products, the properties of products, location information (address) and map information required for direct pickup, and information about benefits obtained through direct pickup (price discounts, promotional gifts, etc.), is stored in the merchant information DB 412.

Further, the purchaser terminal 230 can access the online market server 220 over the network 210 and can use the product trading mediation service provided by the online market server 220 according to the processing of wired/wireless communication performed by the communication interface 420. Each purchaser can subscribe to the service of the online market server 220 as a member who is a client using the service through the purchaser terminal 230. Purchaser information registered by the purchaser who subscribed as a member, for example, a purchaser ID, a password, a contact address, shopping cart information, information about a product for which a bid is being made, a product for which a successful bid has been made, and a product in trading, information about a product for which payment has been completed, delivery information, direct pickup determination information, and final purchase decision (receipt confirmation) information, is stored in the purchaser information DB 411.

In order to mediate the trading of products registered in this way by the merchant, the trading mediation unit 430 may provide information about products for sale, stored in the merchant information DB 412, to the purchaser terminal 230, search for required products matching a keyword received from the purchaser terminal 230 on the basis of the names or details of the product, and provide a list of found products to the purchaser terminal 230.

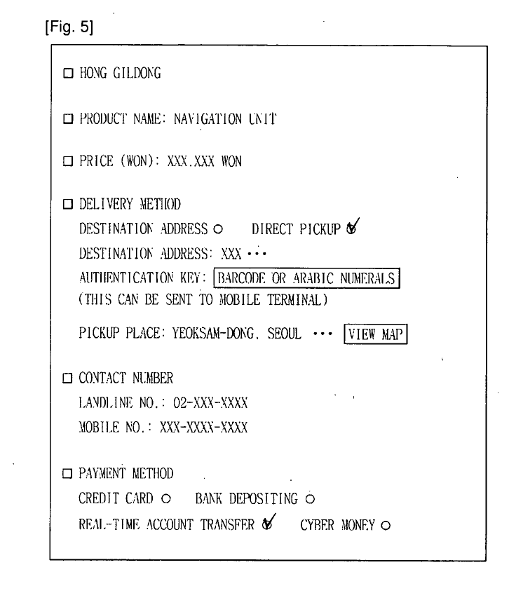

When the purchaser is requested to pay for the selected product, the trading mediation unit 430 can provide payment page information about the product selected by the purchaser to the purchaser terminal 230. As shown in FIG. 5, the payment page displayed on the purchaser terminal 230 on the basis of the payment page information is configured to search the purchaser information DB 411 for purchaser-related information (the name, ID and contact number of the purchaser) or allow the purchaser to personally input the payment information. Further, the payment page is configured to search the merchant information DB 412 for information about a payment target product and an amount of money to be paid and to display the found information. Furthermore, the payment page is configured to allow the purchaser to select a delivery method (destination address receipt, direct pickup, etc.) and a payment method (credit card, bank deposit, real-time account transfer, cyber money, etc.). After all of the required information has been entered in the payment page and has been confirmed, the payment processing unit 470 processes payment through an authentication procedure using a certificate or the like in response to the final payment request received from the purchaser.

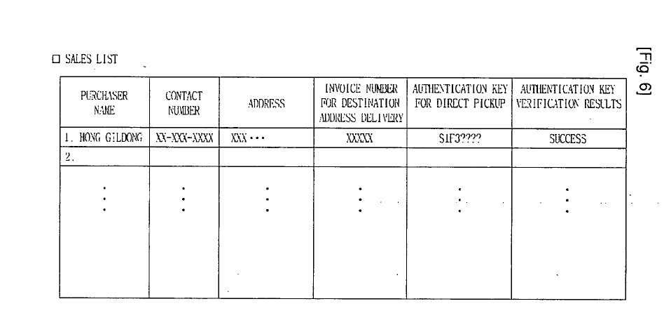

Through such a payment page, the purchaser can select destination address receipt or direct pickup as a delivery method. When the destination address receipt is selected in FIG. 5, the delivery option setting unit 440 can notify the merchant of all information related to delivery, as shown in FIG. 5, so that a product for which payment may be completed can be delivered to the destination address of the purchaser. The notification provided to the merchant may be implemented via email, a short message using a mobile terminal, etc. The information related to delivery may be checked in the list of products for which payment has been completed, displayed in the merchant page of FIG. 6, which is provided by the trading mediation unit 430 when the merchant accesses the online market server 220 through the merchant terminal 240.

In particular, when the delivery option for direct pickup is selected in FIG. 5, the authentication key generation unit 450 generates an authentication key, and the delivery option setting unit 440 may provide pickup information, in which the authentication key is included in pickup place information designated by the merchant (including an address and a map), to the purchaser terminal 230. The delivery option setting unit 440 may be configured to display the message “Please take your previously issued membership card to the pickup place and then pick up your product for which payment has been completed” in the payment page, instead of the authentication key. The authentication key can be provided in the form of Arabic numerals, identifiable characters or barcode information using a random number generator. In addition, instead of the authentication key, the membership card previously issued by the manager can be used as authentication information required to verify that the purchaser is the actual purchaser of the product at the pickup place. The pickup place information provided by the delivery option setting unit 440 includes an address. Additionally, map information, such as an enlarged map or a reduced map showing the area surrounding the address, can be provided as the pickup place information on the basis of a predetermined map database.

The purchaser may personally go to the direct pickup place for the product for which payment has been completed and present a printed sheet or a membership card, including the above-described authentication information, to the merchant in order to pick up the product. The authentication key, provided in the form of Arabic numerals, identifiable characters or barcode information, can be presented in the form of a printed sheet on which information is printed on paper or the like. The delivery option setting unit 440 may provide all pickup information, including pickup place information, to the wired terminal of the purchaser, such as a desktop PC or a notebook PC, through the wired communication means of the communication interface 420. However, according to the circumstances, for better security, the information about the pickup place alone can be provided to the wired terminal of the purchaser through the wired communication means of the communication interface 420. At this time, the message sending unit 460 can create a Short Message Service (SMS)-based, message or a Multimedia Message Service (MMS)-based message, which includes an authentication key, provided in the form of Arabic numerals, identifiable characters or barcode information, and required guidance messages, and can provide the created message to the mobile communication terminal of the purchaser, such as a cellular phone or a PCS phone, through the wireless communication means of the communication interface 420. The barcode information may be included in an MMS-based message in the form of an image and then may be sent. When the authentication key is provided to the mobile communication terminal, the purchaser can present the received message itself to the merchant, without printing the received message, in order to directly pick up the product, for which payment has been completed, at the pickup place.

The merchant can use any one or combinations of various types of authentication information as information used in the transfer of the product. The merchant can be provided with the merchant page of FIG. 6 through the merchant terminal (a wired terminal or a mobile communication terminal) 240, which accesses the online market server 220, in order to transfer the product. As shown in FIG. 6, the merchant page may include a list of products for which payment has been completed, and may include purchaser-related information, such as the name, contact number and address of a purchaser, and delivery information, such as destination address receipt or direct pickup, for each product.

When authentication information presented by the purchaser for the product for which payment has been completed and used to identify the purchaser has been input through the merchant page of FIG. 6, the authentication processing unit 480 updates delivery information about the product. When the authentication information used to identify the purchaser is an authentication key provided in the form of Arabic numerals or identifiable characters, the authentication key can be directly input by the merchant into the authentication key input box of FIG. 6. When the authentication information used to identify the purchaser is barcode information provided in the form of a predetermined image, the barcode information can be read by the barcode reader 250 and can be input. Further, when the authentication information used to identify the purchaser is the member information of a membership card, the authentication information can be read by the card reader 250 and can be input. It is also possible to use two or more of various types of authentication information.

When the authentication key is input through the merchant terminal 240, the authentication processing unit 480 determines whether the input authentication key is the same as the authentication key provided at the time of payment when the delivery option for direct pickup is selected by comparing the two authentication keys each other, thus verifying whether the purchaser is the actual purchaser. Further, the authentication processing unit 480 can verify whether the purchaser is the actual purchaser by inquiring about whether the member information read from the membership card is the same as the information managed in the database as purchaser information.

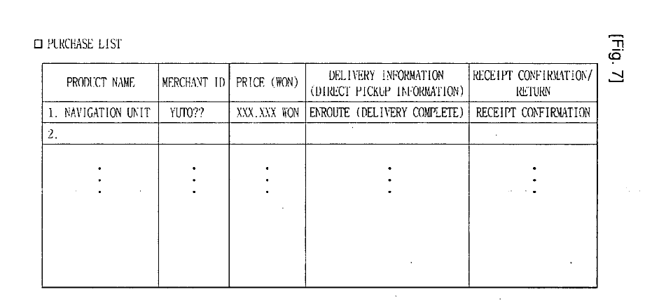

When authentication information is presented by the actual purchaser on the basis of the results of the determination of the authentication processing unit 480, the fact that the authentication key for the product has been verified can be displayed in the merchant page of FIG. 6. Accordingly, the purchaser can receive the product from the merchant. At this time, when the purchaser immediately or subsequently checks the current status of the product for which payment has been completed by accessing the online market server 220 through the purchaser terminal 230, the purchaser can check that the delivery status of the product, the authentication key of which has been verified, in the list of purchased products, has changed to ‘enroute’ or ‘delivery complete’ through the purchaser page of FIG. 7. As described above, before the authentication key is verified by the merchant, the delivery status may be displayed as ‘pending delivery’ or ‘preparing for delivery.’

When receiving the product from the merchant, the purchaser can confirm receipt immediately at the pickup place or later by expressing his or her final intention to purchase the product, without requesting repayment or returning the product. The purchaser determines whether a defect exists in the received product or whether the quality of the product is satisfactory by carefully examining the product, and can finally select ‘purchase decision (receipt confirmation)’ in the purchaser page of FIG. 7 if the product is not a target for repayment or returns. When the receipt confirmation has been received from the purchaser terminal (wired terminal or mobile communication terminal) 230, the receipt confirmation unit 490 completes the mediation of the trading of the product, and provides completion information to the payment processing unit 470. Accordingly, the payment processing unit 470 pays the amount of money to be paid to the merchant for the product in response to this completion. The amount of money to be paid to the merchant is an amount of money remaining after a commission, predetermined according to a commission policy, has been subtracted from the total amount of money paid.

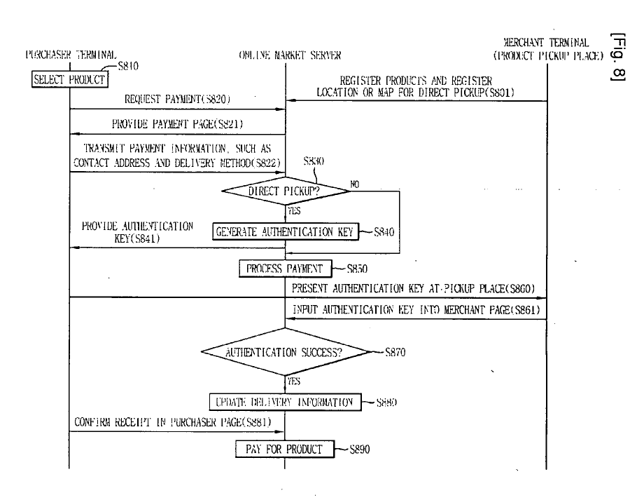

Hereinafter, the principal features of an online market management method according to an embodiment of the present invention will be described with reference to the flowchart of FIG. 8.

First, the merchant may access the online market server 220 through the merchant terminal 240, and may register the selling prices, brand, and features of products for sale, location information (address) and map information required for direct pickup, and benefits obtained through direct pickup (price discounts for a product, promotional gifts, etc.) in the merchant information DB 412 at step S801. The purchaser views the products of various merchants who handle the trading of products in the online market server 220 through the purchaser terminal 230. The purchaser can decide whether to purchase a suitable product by comparing the prices or advantages of products, and can select the product through the purchaser terminal 230 at step S810. The selected product is managed in the shopping cart of the purchaser information DB 411 or the like by the trading mediation unit 430 of the online market server 220. A payment request for the product may be transmitted to the online market server 220 through the purchaser terminal 230 at step S820. Accordingly, the trading mediation unit 430 may provide payment page information about the product of a merchant corresponding to the payment request to the purchaser terminal 230 at step S821. The purchaser can enter or check purchaser-related information, payment target product information, and required payment information, such as a delivery method and a payment method, through the payment page, displayed on the purchaser terminal 230, according to the payment page information provided by the trading mediation unit 430, as shown in FIG. 5, and can transmit the payment information to the online market server 220 if a predetermined transmission tag is clicked as the final payment request at step S822.

Meanwhile, when the delivery option for direct pickup is selected in FIG. 5 at step S830, the authentication key generation unit 450 of the online market server 220 generates an authentication key at step S840. The delivery option setting unit 440 of the online market server 220 may provide pickup information, in which the authentication key or the like is included in pickup place information designated by the merchant (including an address and a map), to the purchaser terminal 230 at step S841. The delivery option setting unit 440 may be configured to display the message “Please take your previously issued membership card to the pickup place and then pick up your product for which payment has been completed” in the payment page, instead of the authentication key. The authentication key can be provided in the form of Arabic numerals, identifiable characters or barcode information. In addition, instead of the authentication key, the membership card, previously issued by the manager, can be used at the pickup place as authentication information required to verify that the purchaser is the actual purchaser for the product.

When the purchaser-related information, the payment target product information, and all payment information, such as a delivery method and a payment method, are transmitted to the online market server 220, the payment processing unit 470 of the online market server 220 processes payment through an authentication procedure using a certificate at step S850.

The purchaser, who has selected the above-described delivery option for direct pickup, can personally visit the pickup place for the product for which payment has been completed and can present a printed sheet or a membership card, in which the authentication information is included, to the merchant so as to pick up the product at step S860. The authentication key, provided in the form of Arabic numerals, identifiable characters or barcode information, can be presented in the form of a printed sheet on which information is printed on paper or the like. The delivery option setting unit 440 may provide all pickup information, including pickup place information, to the wired terminal of the purchaser, such as a desktop PC or a notebook PC. However, according to the circumstances, for better security, the pickup place information alone can be provided to the wired terminal of the purchaser, and the message sending unit 460 can create an SMS-based message or an MMS-based message, which includes an authentication key, provided in the form of Arabic numerals, identifiable characters or barcode information, and required guidance messages, and can provide the created message to the mobile communication terminal of the purchaser, such as a cellular phone or a PCS phone. The barcode information may be included in an MMS-based message in the form of an image and may be sent. When the authentication key is provided to the mobile communication terminal, the purchaser can present the received message itself to the merchant, without printing the received message, in order to directly pick up the product, for which payment has been completed, at the pickup place.

The merchant can use any one or combinations of various types of authentication information as information used to transfer the product. The merchant can input authentication information, which is presented by the purchaser of the product and is used to identify the purchaser, into the merchant page of FIG. 6 through the merchant terminal (wired terminal or mobile communication terminal) 240, which accesses the online market server 220, in order to transfer the product at step S861. Accordingly, the authentication processing unit 480 of the online market server 220 verifies whether the input authentication key, provided in the form of Arabic numerals, identifiable characters or barcode information, is the same as the authentication key provided at the time of payment when the deli very option for direct pickup is selected by comparing the two authentication keys with each other, and updates delivery information about the product for which payment has been completed when authentication has succeeded at steps S870 and S880. Similarly, when member information read from the membership card by the card reader 250 is input as authentication information, the authentication processing unit 480 verifies whether the purchaser is the actual purchaser by inquiring about whether the read member information is the same as the information managed in the database as purchaser information, and updates the delivery information about the product when authentication has succeeded. The case where two or more of various types of authentication information, such as authentication keys and member information of a membership card, are combined and all of the combined information matches is considered authentication success.

When the authentication information is presented by the actual purchaser based on the results of the determination of the authentication processing unit 480, and delivery information is updated, the fact that the authentication key for the product has been verified can be displayed in the merchant page, as shown in FIG. 6. Accordingly, the purchaser can receive the product from the merchant. At this time, when the purchaser immediately or subsequently checks the current status of the product for which payment has been completed by accessing the online market server 220 through the purchaser terminal 230, the purchaser can check, in the purchaser page of FIG. 7, that the delivery status of the product, the authentication key of which has been verified, in the list of purchased products, has changed from ‘pending delivery’ or ‘preparing for delivery’, which is the status before the authentication key is verified, to ‘enroute’ or ‘delivery complete.’

The purchaser determines whether a defect exists in the product and whether the quality of the product is satisfactory by carefully examining the received product, and can finally select ‘purchase decision (receipt confirmation)’ in the purchaser page of FIG. 7 if there is no intention to seek a repayment or return for the product. When such receipt confirmation has been received from the purchaser terminal 230 at step S881, the receipt confirmation unit 490 of the online market server 220 completes the mediation of the trading of the product for which payment has been completed, and notifies the payment processing unit 470 of completion information. Accordingly, the payment processing unit 470 pays the amount of money, remaining after a commission, predetermined according to a commission policy, is subtracted from the total amount of money paid for the product, to the merchant in response to such completion as the amount of money to be paid to the merchant, and can send the money to the account of the merchant. Further, after the purchase decision (receipt confirmation) has been completed in this way, the payment processing unit 470 can enable the discounted price, for example, a price discounted by 10%, to be paid for the product, or enable mileage or membership points to be accumulated in the purchaser information DB corresponding to the purchaser so that the mileage or accumulated points can be used like discount coupons at the time of purchasing other products, with reference to the information related to benefits (price discounts, promotional gifs, etc.), which can be obtained through direct pickup and which have been previously registered by the merchant.

The function used in the method and system disclosed in the present specification can be implemented in the form of computer-readable code in a computer-readable recording medium. The computer-readable recording medium includes all types of recording devices in which data readable by a computer system is stored. Examples of such computer-readable recording media include Read Only Memory (ROM), Random Access Memory (RAM), Compact Disc (CD)-ROM, magnetic tape, a floppy disc, an optical data storage device, etc., and may also include a medium realized in the form of a carrier wave (for example, transmission performed over the Internet). Further, the computer-readable recording medium may be distributed to computer systems connected through a network and computer-readable code may be stored and executed in the computer systems in a distributed manner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the scope of the present invention should not be limited to the embodiments, and should be defined by the accompanying claims and equivalents thereto.

1. An online market management method, comprising:
selecting a delivery option for direct pickup of a product, for which payment may be completed by a purchaser, through a server for mediating trading of products; and
the server performing authentication to identify the purchaser and updating delivery information about the product if authentication information, provided in real time by the server to a purchaser terminal, or authentication information, previously assigned to the purchaser, has been input through a merchant terminal depending on the selection of the delivery option for direct pickup.

2. The online market management method according to claim 1, wherein the authentication information provided in real time comprises an authentication key corresponding to at least one of Arabic numerals, identifiable characters and barcode information.

3. The online market management method according to claim 1, wherein the authentication information previously assigned to the purchaser comprises member information of a membership card issued by a manager of the server.

4. An online market management method of managing an online market through a server for mediating trading of products between a merchant and a purchaser, comprising:
providing pickup information, including information about a pickup place, to a purchaser terminal if a delivery option for direct pickup of a product of the purchaser, for which payment has been completed, is selected; and
updating delivery information about the product when authentication information to identify the purchaser has been input through a merchant terminal at the pickup place.

5. The online market management method according to claim 4, wherein the information about the pickup place comprises at least one of location information and map information, registered together by the merchant in the server when information about products for sale is registered in the server.

6. The online market management method according to claim 4, wherein the authentication information comprises member information recorded in a membership card, previously issued by a manager of the server to a member, or at least one of Arabic numerals, identifiable characters, and barcode information, which is included in the pickup information and is provided to the purchaser terminal at the providing the pickup information.

7. The online market management method according to claim 4, wherein the step of providing the pickup information comprises:
providing information about the pickup place to a wired terminal, and providing an authentication key corresponding to at least one of Arabic numerals, identifiable characters, and barcode information, which is included in the pickup information, to a mobile communication terminal,
wherein the authentication key is used as the authentication information.

8. The online market management method according to claim 4, wherein the step of updating the delivery information is performed such that the authentication information is input through a wired terminal or a mobile communication terminal of the merchant.

9. A recording medium for recording a computer-readable program for performing the method as set forth in claim 1.

10. An online market management system, comprising:
an online market server for mediating trading of products over an Internet, the online market server comprising a control unit for controlling registration of products by a merchant, purchase of products by a purchaser, and a delivery process of each product for which payment has been completed, wherein the control unit is configured to control performance of authentication to identify the purchaser and update of delivery information about a product, for which payment may be completed, based on results of authentication if a delivery option for direct pickup of the product, is selected through a purchaser terminal, and then authentication information, provided in real time by the online market server to the purchaser terminal, or authentication information, previously assigned to the purchaser, is input through a merchant terminal depending on the selection.

11. An online market management system for mediating trading of products between a merchant and a purchaser, comprising:
a trading mediation unit for providing payment page information about a product of a merchant, selected by a purchaser, to a purchaser terminal;
a delivery option setting unit for providing pickup information, including information about a pickup place, to the purchaser terminal when a delivery option for direct pickup of a product for which payment may be completed by the purchaser is selected on a basis of the payment page information; and
an authentication processing unit for updating delivery information about the product when authentication information to identify the purchaser is input through a merchant terminal at the pickup place.

12. The online market management system according to claim 11, wherein:
the delivery option setting unit provides pickup information, including at least one of Arabic numerals, identifiable characters, and barcode information, to the purchaser terminal; and
the authentication processing unit updates delivery information when at least one of member information read from a membership card by a card reader, barcode information read by a barcode reader, and Arabic numerals directly input by the merchant is input through the merchant terminal.

13. The online market management system according to claim 11, further comprising:
a payment processing unit for processing payment in response to a payment request based on the payment page information; and
a receipt confirmation unit for completing mediation of trading of the product if the delivery information is updated and receipt confirmation is received from the purchaser terminal, and
wherein the payment processing unit pays an amount of money to be paid to the merchant for the product in response to the completion.

14. The online market management system according to claim 11, further comprising an authentication key generation unit for generating an authentication key corresponding to at least one of Arabic numerals, identifiable characters, and barcode information, which is used as the authentication information, when the delivery option for direct pickup is selected,
wherein the delivery option setting unit includes the authentication key in the pickup information.

15. The online market management system according to claim 11, wherein:
the delivery option setting unit is configured to provide information about the pickup place to a wired terminal of the purchaser through a wired communication means, and to provide an authentication key corresponding to at least one of Arabic numerals and barcode information, which is included in the pickup information, to a mobile communication terminal of the purchaser through a wireless communication means; and
the authentication processing unit verifies whether the authentication key is input as the authentication information.

16. The online market management system according to claim 11, wherein the authentication processing unit performs authentication on a basis of authentication information input through a wired terminal or a mobile communication terminal of the merchant.

17. A recording medium for recording a computer-readable program for performing the method as set forth in claim 4.
